(19) United States
(12) Patent Application Publication
(10) Pub. No.: US 2013/0111383 A1
(43) Pub. Date: May 2, 2013

(54) SYSTEM AND METHOD FOR MANAGING MEASURED ELEMENTS OF OBJECT

(71) Applicants: CHIH-KUANG CHANG, Tu-Cheng (TW); XIN-YUAN WU, Shenzhen City (CN); ZONG-TAO YANG, Shenzhen City (CN); GEN YANG, Shenzhen City (CN)

(72) Inventors: CHIH-KUANG CHANG, Tu-Cheng (TW); XIN-YUAN WU, Shenzhen City (CN); ZONG-TAO YANG, Shenzhen City (CN); GEN YANG, Shenzhen City (CN)

(21) Appl. No.: 13/629,685

(22) Filed: Sep. 28, 2012

(30) Foreign Application Priority Data
Oct. 31, 2011 (CN) 201110338261.0

(51) Int. Cl. G06F 3/048

(52) U.S. Cl. 715/765

(57) ABSTRACT

A computing device is connected to a measurement machine to measure an object to obtain an image of measured elements of the object. The computing device generates a tree structure to display all of the measured elements. Icons at nodes of the tree structure are generated corresponding to the measured elements. If a cursor points to a particular node of the tree structure, the computing device determines a coordinate range in which the cursor falls. An icon corresponding to the node is determined as being the icon selected according to the range. The computing device displays a measurement program corresponding to the icon.

### BACKGROUND

1. Technical Field

Embodiments of the present disclosure relate to object management systems and methods, and particularly to a system and a method for managing measured elements of an object.

2. Description of Related Art

A measurement machine measures an object to obtain images of measured elements of the object. A tree structure is often used to show the measurement elements of the object. However, the measurement elements may be shown on the tree structure out of order, and thus it is time-consuming for a user to find a desired measured element. If the user wants to check a measurement program of the measured element, the user cannot open the measurement program on the tree structure but must make reference elsewhere, which may also be time-consuming.

### BRIEF DESCRIPTION OF THE DRAWINGS

FIG. 1 is a block diagram of one embodiment of a computing device comprising a management system.

FIG. 2 is a block diagram of one embodiment of the function modules of the management system in FIG. 1.

FIG. 3 is a flowchart illustrating one embodiment of a method for managing measured elements of an object.

FIG. 4 shows one embodiment of an interface displaying measured elements of an object.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

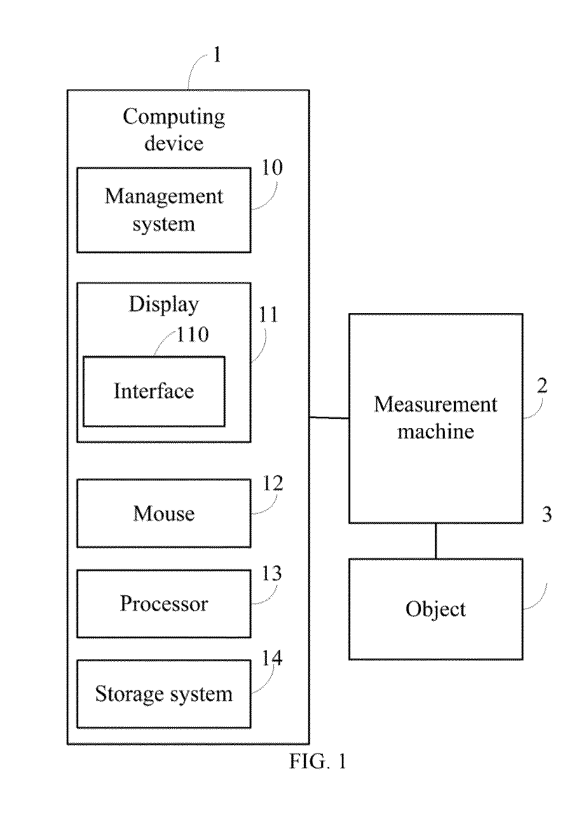

FIG. 1 is a block diagram of one embodiment of a computing device 1 including a management system 10, a display 11 and a mouse 12. The computing device 1 is electronically connected to a measurement machine 2. The measurement machine 2 measures an object 3 to obtain images of measured elements of the object 3. The display 11 provides an interface 110 to display the measured elements of the object 3.

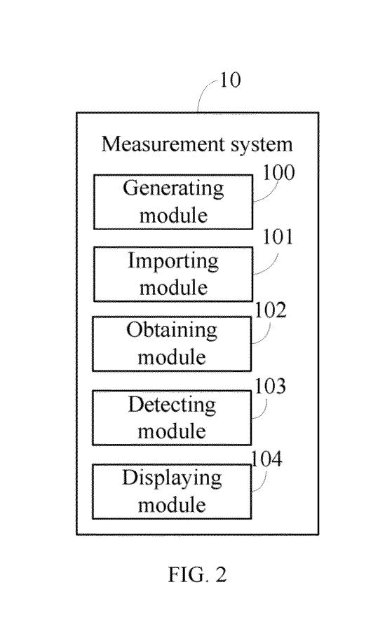

In an exemplary embodiment, the computing device 1 includes at least one processor 13 and a storage system 14. The management system 10 may include one or more modules (also described in FIG. 2) comprising computerized code in the form of one or more programs that are stored in the storage system 14. In one embodiment, the storage system 14 may be a magnetic storage system, an optical storage system, or other suitable storage medium. The computerized code includes instructions that are executed by the at least one processor 13 to provide functions for the one or more modules described below. The storage system 14 stores information of the measured elements of the object 3. In one embodiment, information of each measured elements of the object 3 may include a name of the measured element, a name of a group that the measured element belongs to, a type of the measured element, and a measurement program for measuring the measured element. The group may be a group of points, a group of lines, or a group of circles. The icon index indicates a type of each measured element. The types of the measured element may be a point, a line, or a circle.

As shown in FIG. 2, the management system 10 includes a generating module 100, an importing module 101, an obtaining module 102, a detecting module 103, and a displaying module 104.

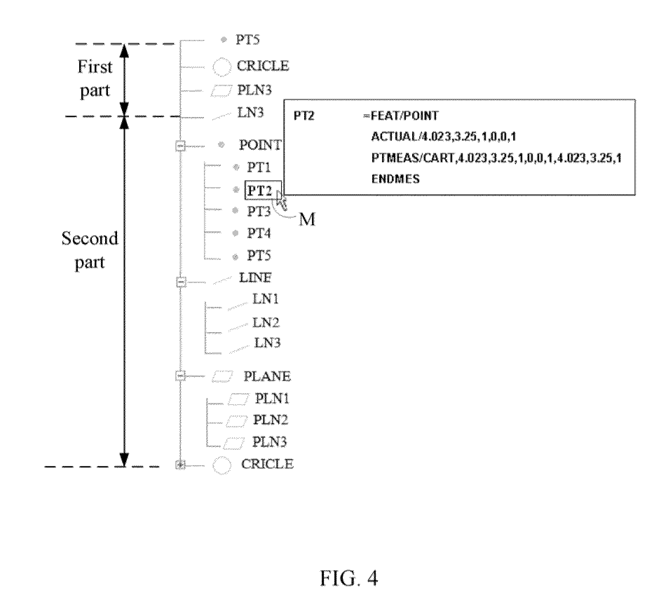

The generating module 100 generates a tree structure on the interface 110 showed on the display 11. In one embodiment, the tree structure may include a first part and a second part, as shown in FIG. 4. The first part displays names and icons of all the measured elements of the object 3. The second part displays names and icons of measured elements which have been previously used by a user.

The importing module 101 imports information of all the measured elements of the object 3 from the storage system 14, and stores the information of all the measured elements in an array.

The generating module 100 generates an icon of each measured element as a node in the tree structure according to the type of each measured element, and gives a name to each icon as the name of the corresponding measured element.

The obtaining module 102 obtains a coordinate range of each icon of the tree structure, and stores the coordinate range of each icon in the array. In one embodiment, the coordinate range of an icon may be a rectangle around the icon node. As shown in FIG. 4, the point “PT2” is a node of the tree structure and the rectangle M is the coordinate range of the point “PT2”.

The detecting module 103 detects a location of a cursor (e.g., of the mouse 12 of the computing device 1) that is moved on the tree structure displayed on the display 11, determines a coordinate range in which the cursor is located, and makes a determination as to the icon corresponding to the determined range.

The displaying module 104 obtains a measurement program of a measured element corresponding to the determined icon and displays the measurement program. If double clicks have been executed on the measurement program, the displaying module 104 displays an editable state of the measurement program, namely, the measurement program can be edited by the user.

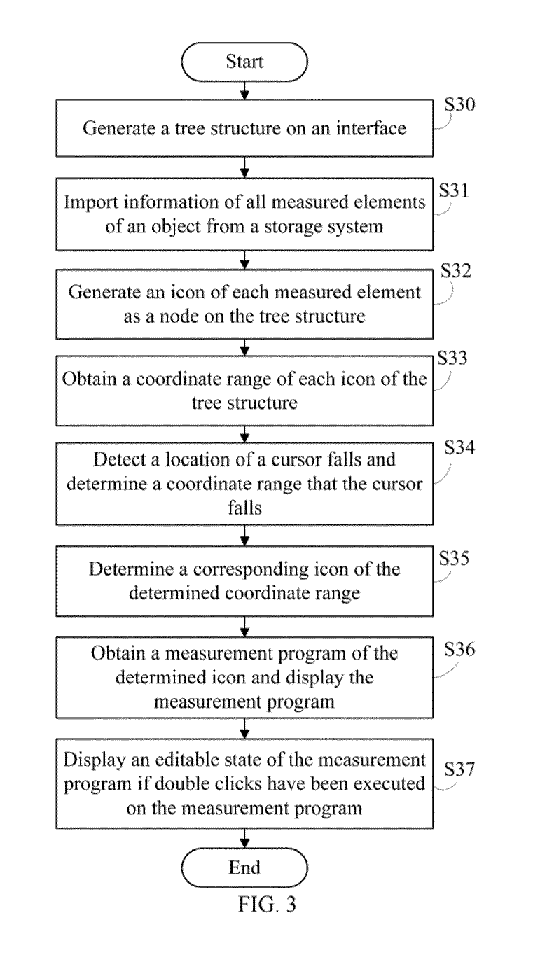

FIG. 3 is a flowchart illustrating a method for managing measured elements of an object. Depending on the embodiment, additional steps may be added, others removed, and the ordering of the steps may be changed.

In step S30, the generating module 100 generates a tree structure on the interface 110.

In step S31, the importing module 101 imports information of all the measured elements of the object 3 from the storage system 14, and stores the information of all the measured elements in an array.

In step S32, the generating module 100 generates an icon of each measured element as a node in the tree structure according to the type of each measured element, and gives each icon a name corresponding to the name of the measured element.

In step S33, the obtaining module 102 obtains a coordinate range of each icon of the tree structure, and stores the coordinate range of each icon in the array.

In step S34, the detection module 104 detects a location of a cursor on the tree structure displayed on the display 11, and determines a coordinate range in which the cursor is located.

In step S35, the detection module 104 makes a determination as to the icon which corresponds to the determined range.

In step S36, the displaying module 104 obtains a measurement program of a measured element corresponding to the determined icon and displays the measurement program.

In step S37, executing a double click on the measurement program causes the displaying module 104 to display the measurement program in an editable state.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a storage system;
at least one processor; and
one or more programs being stored in the storage system and executable by the at least one processor, the one or more programs comprising:
a generating module that generates a tree structure that is displayed on an interface of a display of the computing device;
an importing module that imports information of measured elements of an object measured by a measurement machine connected with the computing device, wherein the information of each measured element comprises a measurement program;
the generating module further generates an icon of each measured element as a node in the tree structure;
an obtaining module that obtains a coordinate range of each icon of the tree structure;
a detecting module that detects a location of a cursor on the tree structure displayed on the display, determines a coordinate range in which the cursor is located, and determines a corresponding icon of the determined range; and
a displaying module that displays the measurement program of a measured element corresponding to the determined icon on the interface.

2. The computing device as described in claim 1, wherein the tree structure comprises a first part and a second part.

3. The computing device as described in claim 2, wherein the first part displays names and icons of the measured elements of the object, and the second part displays names and icons of measured elements which are previously used by a user.

4. The computing device as described in claim 1, wherein the importing module further stores the information of each measured element in an array.

5. The computing device as described in claim 4, wherein the obtaining module further stores the coordinate range of each icon in the array.

6. The computing device as described in claim 1, wherein the displaying module further displays an editable state of the measurement program when double clicks have been executed on the measurement program displayed on the interface.

7. A computing device-based method for managing measured elements, comprising:
generating a tree structure that is displayed on an interface of a display of a computing device;
importing information of measured elements of an object measured by a measurement machine connected with the computing device, wherein the information of each measured element comprises a measurement program;
generating an icon of each measured element as a node in the tree structure;
obtaining a coordinate range of each icon of the tree structure;
detecting a location of a cursor on the tree structure displayed on the display, and determining a coordinate range in which the cursor is located;
determining an icon corresponding to the determined range; and
displaying the measurement program of a measured element corresponding to the determined icon on the interface.

8. The method as described in claim 7, wherein the tree structure comprises a first part and a second part.

9. The method as described in claim 8, wherein the first part displays names and icons of the measured elements of the object, and the second part displays names and icons of measured elements which are previously used by a user.

10. The method as described in claim 7, wherein the method further comprises: storing the information of each measured element in an array.

11. The method as described in claim 10, wherein the method further comprises: storing the coordinate range of each icon in the array.

12. The method as described in claim 7, wherein the method further comprises: displaying an editable state of the measurement program if double clicks have been executed on the measurement program displayed on the interface.

13. A non-transitory storage medium having stored thereon instructions that, when executed by a processor, cause the processor to perform a method for managing measured elements, the method comprising:
generating a tree structure that is displayed on an interface of a display of a computing device;
importing information of measured elements of an object measured by a measurement machine connected with the computing device, wherein the information of each measured element comprises a measurement program;
generating an icon of each measured element as a node in the tree structure;
obtaining a coordinate range of each icon of the tree structure;
detecting a location of a cursor on the tree structure displayed on the display, and determining a coordinate range in which the cursor is located;
determining an icon corresponding to the determined range; and
displaying the measurement program of a measured element corresponding to the determined icon on the interface.

14. The non-transitory storage medium as described in claim 13, wherein the tree structure comprises a first part and a second part.

15. The non-transitory storage medium as described in claim 14, wherein the first part displays names and icons of the measured elements of the object, and the second part displays names and icons of measured elements which are previously used by a user.

16. The non-transitory storage medium as described in claim 13, further comprising: storing the information of each measured element in an array.

17. The non-transitory storage medium as described in claim 16, further comprising: storing the coordinate range of each icon.

18. The non-transitory storage medium as described in claim 13, further comprising: displaying an editable state of the measurement program if double clicks have been executed on the measurement program displayed on the interface.
